(19) United States
(12) Patent Application Publication
(10) Pub. No.: US 2021/0224856 A1
(43) Pub. Date: Jul. 22, 2021

(54) METHODS AND APPARATUSES FOR DETERMINING THE EFFECTIVENESS OF AN ADVERTISEMENT CAMPAIGN

(71) Applicant: Walmart Apollo, LLC, Bentonville, AR (US)

(72) Inventors: Qu LU, San Jose, CA (US); Ka Wai YUNG, San Francisco, CA (US); Peng YANG, San Jose, CA (US); Gurgen TUMANYAN, San Francisco, CA (US)

(21) Appl. No.: 16/745,213

(22) Filed: Jan. 16, 2020

(51) Int. Cl. G06Q 30/02

(52) U.S. Cl. CPC G06Q 30/0269; G06Q 30/0244; G06Q 30/0277; G06Q 30/0255; G06Q 30/0246

(57) ABSTRACT

A system for determining the effectiveness of an advertising campaign on an electronic advertising platform includes a computing device configured to obtain exposure data characterizing a user's interaction with the advertising platform during an advertising campaign and to categorize the user into one of a plurality of exposure bins based on the exposure data. The computing device may be further configured to obtain sales feature data characterizing the user's purchase behavior on the advertising platform both before and during the advertising campaign and to categorize the user into one of a plurality of sales clusters based on the sales feature data. The computing device may be further configured to define a control group comprising unexposed users categorized into the same exposure bins and sales clusters as exposed users and to compare purchase data of the exposed users to the purchase data of the control group.

### TECHNICAL FIELD

The disclosure relates to methods and apparatuses for determining the effectiveness of an advertisement campaign. More specifically, the disclosure relates to methods and apparatuses for determining the effectiveness of an advertisement campaign that has been delivered to a group of users on an electronic advertising platform such as a website or mobile application.

### BACKGROUND

At least some websites and applications, such as retailer websites, mobile applications or other e-commerce environments, display advertisements to users during an advertising campaign while the user is viewing various items or information on the website. It is useful to measure and/or quantify the effectiveness of such advertising campaigns to determine, for example, whether the advertising campaign results in increased sales, increased clickthough rates, increased views, improved customer satisfaction, increased spend, increased time spent on the website or mobile application or other effectiveness measures. It can be difficult, however, to isolate the effects of an advertising campaign from other factors and/or to determine reproducible, stable measures of the effectiveness of an advertising campaign. Therefore, there is a need for improved methods and apparatuses that can determine reproducible, unbiased and stable measures of an effectiveness of an advertising campaign.

### SUMMARY

The embodiments described herein are directed to automatically preparing a test group and a control group of users associated with an electronic advertising platform. The test group and the control group can be used to evaluate the performance and/or effectiveness of an advertising campaign that is presented to users on the advertising platform. The examples and embodiments described herein may use user data, exposure data, sales feature data and purchase data to categorize the users into exposure bins and sales clusters to define a control group of users that can be compared against the test group of users that have been exposed to the advertising campaign. The methods of categorization and selection of the control group of users allows the effects of the advertising campaign to be isolated from other randomness or biasing factors that may otherwise be introduced when comparing groups of users on an electronic advertising platform. The apparatuses and methods of the present disclosure allow consistent and reproducible metrics to be determined that can quantify the effectiveness and/or performance of an advertising campaign.

In accordance with various embodiments, exemplary systems may be implemented in any suitable hardware or hardware and software, such as in any suitable computing device. For example, in some embodiments, a computing device is configured to obtain exposure data characterizing a user's interaction with an advertising platform during an advertising campaign and to categorize the user into one of a plurality of exposure bins based on the exposure data. The computing device may also obtain sales feature data characterizing the user's purchase behavior on the advertising platform both before and during the advertising campaign and categorize the user into one of a plurality of sales clusters based on the sales feature data. The computing device may further define a control group comprising unexposed users categorized into the same exposure bins and sales clusters as exposed users and compare purchase data of the exposed users to the control group to determine an effect of the advertising campaign.

In some embodiments, a method is provided that includes obtaining exposure data characterizing a user's interaction with an advertising platform during an advertising campaign and categorizing the user into one of a plurality of exposure bins based on the exposure data. The method may also include obtaining sales feature data characterizing the user's purchase behavior on the advertising platform both before and during the advertising campaign and categorizing the user into one of a plurality of sales clusters based on the sales feature data. The method may also include defining a control group comprising unexposed users categorized into the same exposure bins and sales clusters as exposed users and comparing purchase data of the exposed users to the control group to determine an effect of the advertising campaign.

In yet other embodiments, a non-transitory computer readable medium has instructions stored thereon, where the instructions, when executed by at least one processor, cause a computing device to perform operations that may include obtaining exposure data characterizing a user's interaction with an advertising platform during an advertising campaign and categorizing the user into one of a plurality of exposure bins based on the exposure data. The operations may also include obtaining sales feature data characterizing the user's purchase behavior on the advertising platform both before and during the advertising campaign and categorizing the user into one of a plurality of sales clusters based on the sales feature data. The operations may also include defining a control group comprising unexposed users categorized into the same exposure bins and sales clusters as exposed users and comparing purchase data of the exposed users to the control group to determine an effect of the advertising campaign.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is an illustration of a network system that includes an advertising campaign evaluation device in accordance with some embodiments;

FIG. 2 is a block diagram of the advertising campaign evaluation device of the network system of FIG. 1 in accordance with some embodiments;

FIG. 3 is a block diagram illustrating examples of various portions of the network system of FIG. 1 including the advertising campaign evaluation device in accordance with some embodiments;

FIG. 4 is a flow chart of an example method of evaluating an advertising campaign that can be carried out by the advertising campaign evaluation device in accordance with some embodiments; and

FIG. 5 is a flow chart of an example method of defining a control group that can be carried out in addition to or as part of one or more steps of the method of FIG. 4.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

The examples and teachings of the present disclosure relate to apparatuses and methods for evaluating and/or determining the effectiveness of advertising campaigns. More particularly, the methods and apparatuses of the present disclosure can be used to automatically compare the behaviors, and purchase activity of users that have been exposed to an advertising campaign on a website or other e-commerce platform such as a mobile application. Many websites, applications or other tools on personal computing devices can operate to present advertisements to users while a user surfs, browses, shops, or views items during the user's interactions with the web site or other e-commerce platform. It can be desirable to understand the effectiveness of particular advertisements and/or particular advertising campaigns in order to improve the performance of future advertising campaigns. The understanding of the performance of advertising campaigns can also be used to plan or budget advertising activities and to sell advertising campaigns to internal or external customers.

Conventional apparatuses and methods for evaluating advertising campaigns can compare various measureables for both users that are exposed to the advertising campaign to users that are not exposed to the advertising campaign. The difficulties with conducting such comparisons is the need to isolate the effect of the advertising campaign from other factors that may effect the measurable that an evaluator is using to quantify the performance of the advertising campaign. Various factors that exist between groups of users that are exposed to an advertising campaign and those that are not exposed to an advertising campaign can induce biases that cloud the conclusions that can be drawn from evaluation of advertising campaigns. Such difficulties in the evaluation of advertising campaigns are particularly troublesome in the context of advertising campaigns that are conducted in an electronic environment such as a website, mobile application, e-commerce application or other electronic advertising platform. The difficulties are exacerbated in electronic advertising platforms because demographic, environmental, economic, or other external factors can be unknown for the users that are active in the electronic advertising platform. There exists a need, therefore, for improved methods and apparatuses that can determine the effectiveness of advertising campaigns, particularly advertising campaigns on electronic advertising platforms, to address the problems associated with the advertising platform. The methods and apparatuses of the present disclosure, for example, can define control groups of users that minimize and/or reduce the bias associated with external factors in order to better isolate the effect of an advertising campaign.

The methods and apparatuses of the present disclosure can be implemented in the context of an advertising platform such as an electronic advertising platform. Example advertising platforms include websites, mobile applications, e-commerce platforms, social networking sites, or the like. In one example, the methods and apparatuses of the present disclosure can be implemented in connection with a retailer's website in which users can browse, select and/or purchase various items. In such an environment, the retailer's website can present an advertising campaign to users in which a product or service is presented to the user as a banner advertisement, recommended listing, pop-up advertisement or like. In other examples, the advertising campaign can include other types of advertisements including photos, videos, wallpapers, audio and other messaging.

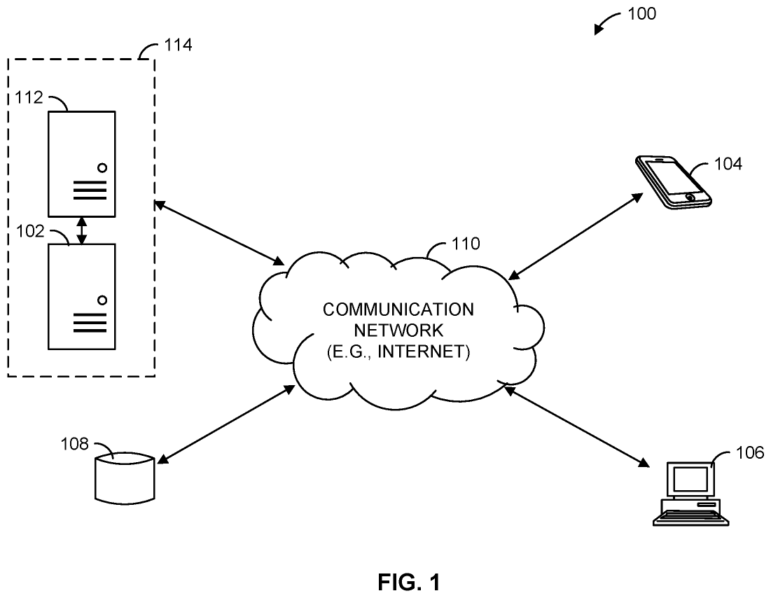

Turning to the drawings, FIG. 1 illustrates a block diagram of a network system 100 that includes an advertising campaign evaluation device 102 (e.g., a server, such as an application server) and a content delivery device 112 (e.g., a server, such as a web server) that together can comprise an advertising platform 114. The network system 100 can also include a mobile user computing device 104 (e.g., a smart phone), a desktop user computing device 106, and database 108 operatively coupled over communication network 110. The advertising campaign evaluation device 102, content delivery device 112 and multiple user computing devices 104, 106 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit data to, and receive data from, communication network 110.

In some examples, the advertising campaign evaluation device 102 and the content delivery device 112 can be a computer, a workstation, a laptop, a server such as a cloud-based server, or any other suitable device. In some examples, each of multiple user computing devices 104, 106 can be a cellular phone, a smart phone, a tablet, a personal assistant device, a voice assistant device, a digital assistant, a laptop, a computer, or any other suitable device.

Advertising campaign evaluation device 102 is operable to communicate with database 108 over communication network 110. For example, advertising campaign evaluation device 102 can store data to, and read data from, database 108. Database 108 can be a remote storage device, such as a cloud-based server, a memory device on another application server, a networked computer, or any other suitable remote storage. Although shown remote to advertising campaign evaluation device 102, in some examples, database 108 can be a local storage device, such as a hard drive, a non-volatile memory, or a USB stick.

Communication network 110 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 110 can provide access to, for example, the Internet.

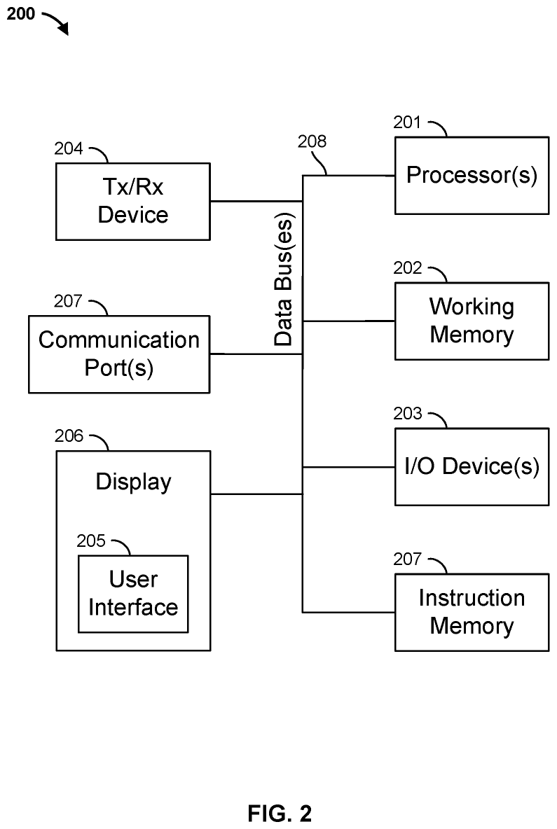

FIG. 2 illustrates an example computing device 200. The advertising campaign evaluation device 102, the content delivery device 112 and/or the user computing devices 104, 106 may include the features shown in FIG. 2. For the sake of brevity, FIG. 2 is described relative to the advertising campaign evaluation device 102. It should be appreciated, however, that the elements described can be included, as applicable, in the content delivery device 112 and/or user computing devices 104, 106.

As shown, the advertising campaign evaluation device 102 can be a computing device 200 that may include one or more processors 202, working memory 204, one or more input/output devices 206, instruction memory 208, a transceiver 212, one or more communication ports 214, and a display 216, all operatively coupled to one or more data buses 210. Data buses 210 allow for communication among the various devices. Data buses 210 can include wired, or wireless, communication channels.

Processors 202 can include one or more distinct processors, each having one or more cores. Each of the distinct processors can have the same or different structure. Processors 202 can include one or more central processing units (CPUs), one or more graphics processing units (GPUs), application specific integrated circuits (ASICs), digital signal processors (DSPs), and the like.

Processors 202 can be configured to perform a certain function or operation by executing code, stored on instruction memory 208, embodying the function or operation. For example, processors 202 can be configured to perform one or more of any function, method, or operation disclosed herein.

Instruction memory 208 can store instructions that can be accessed (e.g., read) and executed by processors 202. For example, instruction memory 208 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 202 can store data to, and read data from, working memory 204. For example, processors 202 can store a working set of instructions to working memory 204, such as instructions loaded from instruction memory 208. Processors 202 can also use working memory 204 to store dynamic data created during the operation of advertising campaign evaluation device 102. Working memory 204 can be a random access memory (RAM) such as a static random access memory (SRAM) or dynamic random access memory (DRAM), or any other suitable memory.

Input-output devices 206 can include any suitable device that allows for data input or output. For example, input-output devices 206 can include one or more of a keyboard, a touchpad, a mouse, a stylus, a touchscreen, a physical button, a speaker, a microphone, or any other suitable input or output device.

Communication port(s) 214 can include, for example, a serial port such as a universal asynchronous receiver/transmitter (UART) connection, a Universal Serial Bus (USB) connection, or any other suitable communication port or connection. In some examples, communication port(s) 214 allows for the programming of executable instructions in instruction memory 208. In some examples, communication port(s) 214 allow for the transfer (e.g., uploading or downloading) of data, such as user data, exposure data, sales feature data and/or purchase data.

Display 216 can display a user interface 218. User interfaces 218 can enable user interaction with the advertising campaign evaluation device 102. For example, user interface 218 can be a user interface that allows an operator to interact, communicate, control and/or modify different messages or features that may be presented or otherwise displayed to a user by a network-enabled tool. The user interface 218 can, for example, display the results of the evaluation of an advertising campaign using different textual, graphical or other types of graphs, tables or the like. In some examples, a user can interact with user interface 218 by engaging input-output devices 206. In some examples, display 216 can be a touchscreen, where user interface 218 is displayed on the touchscreen.

Transceiver 212 allows for communication with a network, such as the communication network 110 of FIG. 1. For example, if communication network 110 of FIG. 1 is a cellular network, transceiver 212 is configured to allow communications with the cellular network. In some examples, transceiver 212 is selected based on the type of communication network 110 advertising campaign evaluation device 102 will be operating in. Processor(s) 202 is operable to receive data from, or send data to, a network, such as communication network 110 of FIG. 1, via transceiver 212.

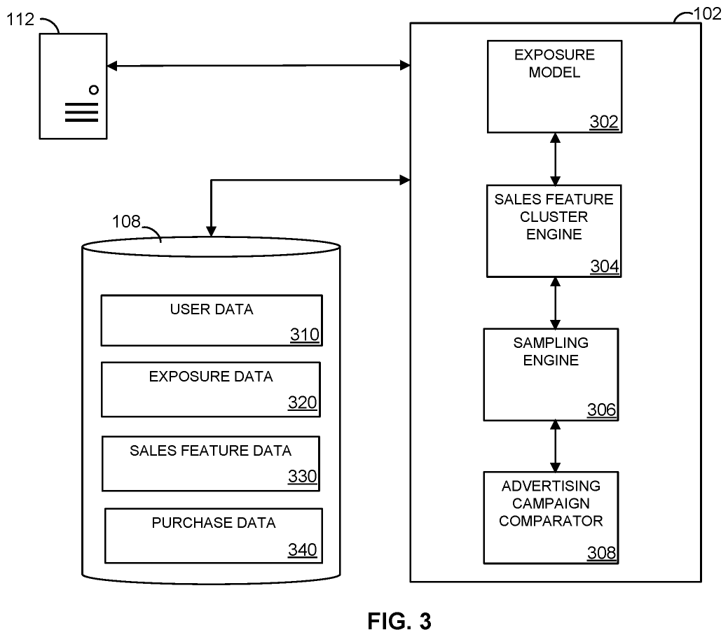

Referring now to FIG. 3, an advertising campaign evaluation device 102 is shown. In this illustration, the network 110 is not shown. However, it should be appreciated that the communication between the content delivery device 112, the database 108 and the advertising campaign evaluation device 102 can be achieved by use of the network 110 as previously described. In the example shown, the content delivery device 112 can be in communication with the advertising campaign evaluation device 102. The content delivery device 112 can operate to deliver advertising content and other content to a personal computing device, such as mobile user computing device 104 and/or desktop user computing device 106 (not shown).

The advertising campaign evaluation device 102 can include an exposure model 302, a sales feature cluster engine 304, a sampling engine 306 and an advertising campaign comparator 308. These aspects of the advertising campaign evaluation device 102 can be implemented using any suitable methodology. In some examples, the exposure model 302, the sales feature cluster engine 304, the sampling engine 306 and the advertising campaign comparator 308 can be implemented using executable instructions that can be executed by one or more processors. In some examples, the exposure model 302, the sales feature cluster engine 304, the sampling engine 306 and/or the advertising campaign comparator 308 can include one or more open source tools that can be incorporated either locally or remotely.

In some embodiments, the models and/or the engines of the present disclosure includes data models created using machine learning. The machine learning may involve training a model in a supervised or unsupervised setting. The data models may be trained to learn relationships between various groups of data. The data models may be based on a set of algorithms that are designed to model abstractions in data by using vector quantization, heuristic algorithms, and/or a number of processing layers. The processing layers may be made up of non-linear transformations. The data models may include, for example, neural networks, convolutional neural networks and deep neural networks. The data models may be used in large-scale relationship-recognition tasks. The models can be created by using various open-source and proprietary machine learning tools known to those of ordinary skill in the art.

As shown, the exposure model 302, the sales feature cluster engine 304, the sampling engine 306 and/or the advertising campaign comparator 308 can be coupled to each other. The exposure model 302, the sales feature cluster engine 304, the sampling engine 306 and/or the advertising campaign comparator 308 can operate to perform one or more of the example methods that will be described in further detail below.

The exposure model 302 can be an aspect of the advertising campaign evaluation device 102 that can determine a likelihood that a user will be exposed to an advertising campaign. The advertising platform 114 (FIG. 1) can deliver advertising campaigns to users. Not all users, however, may be exposed to a particular advertising campaign. This may be the case because an advertising campaign can, for example, be delivered during a predetermined period of time, during predetermined time intervals, to predetermined types of users, or in predetermined circumstances. Advertising campaigns, for example, can be delivered when a user views a particular item on a website or e-commerce application or when a user views a particular category of item or searches for a particular item or category of items. Thus, not all users that are associated with, have registered on or may interact with the advertising platform 114 may be exposed to an advertising campaign. The exposure model 302 can obtain user data 310 and/or exposure data 320 to determine a likelihood that a user will be exposed to an advertising campaign.

The user data 310 can be any suitable data to identify unique users of the advertising platform 114. In some examples, the user data 310 can be user identification numbers, user ID's, IP addresses, user names or the like. As shown, the user data 310 can be stored in database 108. In other examples, the user data 310 can be stored locally to the advertising campaign evaluation device 102 or in other storage locations.

The exposure data 320 can be any suitable data that can be used by the exposure model 302 that can characterize a user's exposure to the advertising platform 114. The exposure data can be used by the exposure model 302 to determine a likelihood that a user will be exposed to an advertising campaign. In some examples, the exposure data can be data that identifies how many times a user has accessed or viewed the advertising platform 114. In other examples, the exposure data 320 can be a time, a count or other measure of a user's length of browsing or of a user's interaction with the advertising platform 114. For example, the exposure data 320 can include a count of the number of instances that a user accessed or browsed a website or e-commerce application during a period of time. In such examples, the exposure data 320 can include a count of the number of instances a user accessed a website per day, per week, per month or other suitable period of time.

The sales feature cluster engine 304 can operate to categorize and/or cluster users into one or more groups based on the user's purchasing behavior with the website or other e-commerce platform. The sales feature cluster engine 304 can operate to identify similar purchasing behaviors between users that are exposed to the advertising campaign and users that are not exposed to the advertising campaign. The identification of users that have similar purchasing behaviors but have not been or are likely not to be exposed to the advertising campaign is useful in order to define a control group. The control group, in turn, can be used to evaluate the effectiveness or performance of the advertising campaign.

The sales feature cluster engine 304 can use the user data 310 and the sales feature data 330 to identify users that can be defined as part of the control group. The sales feature data 330 can be any suitable data that can characterize or describe a user's sales or purchase data on a website, mobile application or other e-commerce platform. The sales feature data 330 can include, for example, the number of purchases that a user makes on a website, the size or value of purchases made by a user on a website, the number of new purchases made by a user on a website, the number of repeat purchases on a website, and the like. The previous examples of the sales feature data 330 can include such information for different periods such as, purchase behavior prior to an advertising campaign (e.g., purchases made 1 year, 6 months, 3 months, 1 month, 1 week, or 1 day in advance of an advertising campaign) and purchase behavior during an advertising campaign. The sales feature data 330 can also include channel information regarding a sales channel used to make a purchase. For example, the channel information can identify whether a purchase was made online, in a store or other related information. In other examples, other types of sales feature data 330 can be used.

The advertising campaign evaluation device 102 can also include the sampling engine 306. The sampling engine 306 can operate to determine whether the control group of users is of a sufficient size to permit an unbiased, stable and repeatable evaluation of the advertising campaign to be conducted. If the sampling engine 306 determines that the size of the control group is too low, the sampling engine 306 can operate to exclude or ignore a group when test groups are compared against control groups. The sampling engine 306 can also operate to compare the size of the control group to the size of the test group. The sampling engine 306 can add replacement users to the control group in some examples when it determines that the control group is smaller than the test group. The sampling engine 306 can continue to sample replacement users to the control group until the control group has a sufficient size (e.g., the same size as the test group) to allow a stable and repeatable evaluation of the advertising campaign to be conducted. In some examples and as further described below, the sampling engine 306 can use bootstrapping to improve the evaluation of the advertising campaign.

As further shown, the advertising campaign evaluation device 102 can also include the advertising campaign comparator 308. The advertising campaign comparator 308 can operate to compare the purchasing behavior of the users that were exposed to the advertising campaign to the unexposed users that have similar purchasing behavior to the exposed users (i.e., the control group). The advertising campaign comparator 308 can use any suitable evaluation tools to conduct such comparisons. The advertising campaign comparator 308, for example, can use statistical analysis to determine various quantifiable metrics regarding the exposed users versus the control group. Example metrics that may be determined by the advertising campaign comparator include clickthrough rates, spend per user, in-store revenue, online revenue, number of views, session time per user and the like. The advertising campaign comparator 308 can present such metrics in various formats using various graphical user interfaces including tables, graphs, charts, heat mapping and the like.

The advertising campaign comparator 308 can access user data 310 and purchase data 340 in order to determine the comparisons and metrics previously described. The purchase data 340 can be any suitable data that characterizes user's interaction with the advertising campaign including clicks on presented advertisements and purchases that may be made by the user on the website, mobile application, or e-commerce platform. In addition, the purchase data 340 can also include purchases that are made at a physical retail store if the retailer has both online e-commerce platforms and physical retail stores.

As discussed above, conventional methods of evaluating the effectiveness or performance of an advertising campaign can be difficult particularly in the context of an advertising campaign delivered via a website, mobile application or other e-commerce platform, such as the advertising platform 114. In conventional methods of evaluating advertising campaigns, a test group (the group of customers that are exposed to the advertising campaign) can be compared against a control group (a group of customers that are not exposed to the advertising campaign). In controlled settings, the effects of external factors can be isolated to better determine what effect the exposure to an advertising campaign has on the customer's purchasing behavior. In the context of a website, mobile application or other e-commerce platform, it is difficult to isolate the effects of the advertising campaign from other external factors. This can be particularly true because there may not be enough users that were not exposed to the advertising campaign, or there is some inherent bias that is introduced into the sample of users during the advertising campaign.

Conventional methods of evaluating advertising campaigns can attempt to account for such randomness or biases that may exist during advertising campaigns by applying correction factors to the test or the control groups. Such correction factors may be applied using historical purchase behavior or other methodology. This technique of accounting for randomness or bias by the use of correction factors often leads to results that are unstable and not reproducible. These conventional evaluation methods also are difficult to maintain and are not scalable because they are often built for specific scenarios and environmental conditions that may exist when a particular advertising campaign may be implemented.

The methods described below can use one or more of the elements of the network system 100, including the advertising campaign evaluation device 102, to address the drawbacks and difficulties of conventional methods described above. The methods and apparatuses described herein are consistent and reproducible because the aggressive correction factors described above may not be required. In addition, the methods and apparatuses of the present disclosure can be scaled to different size advertising campaigns and can be easily maintained.

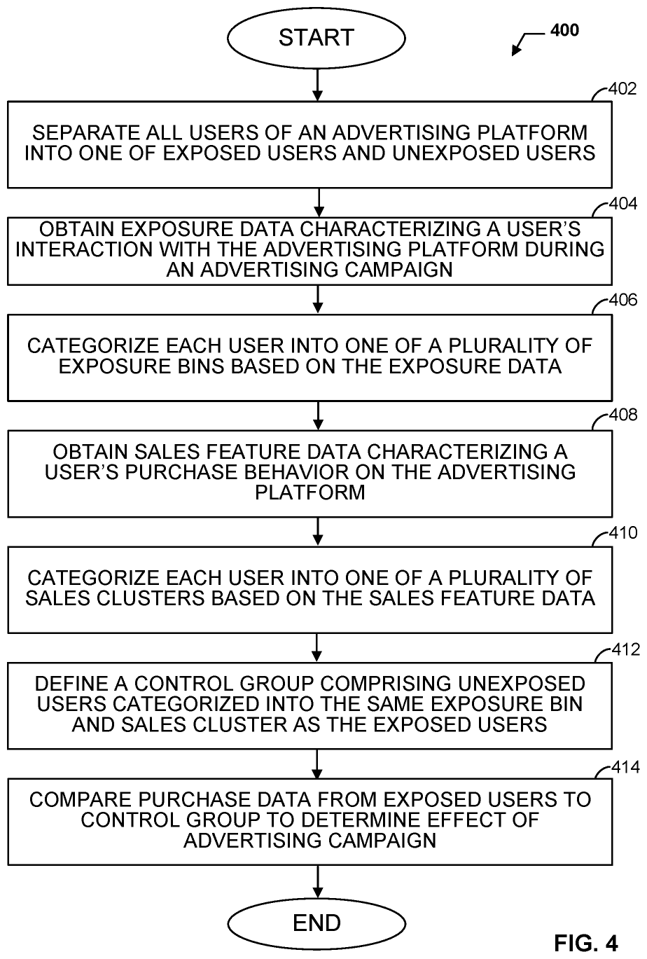

FIG. 4 illustrates an example method 400 of determining an effectiveness of an advertising campaign. The method 400 can be performed, for example, to determine the effectiveness of an advertising campaign that has been shown to users of an advertising platform such as a website, mobile application or other e-commerce platform. The method 400 is described with reference to the example advertising platform 114 and the advertising campaign evaluation device 102. As can be appreciated, the method 400 and various steps thereof can also be performed using other example systems, apparatuses and devices.

For various reasons, not all users that visit or browse the advertising platform may have seen or been exposed to advertisements in an advertising campaign. In instances where the advertisements of the advertising campaign are presented to a user during a user's visit to the advertising platform, the users are called exposed users. The users that visit the advertising platform during the advertising campaign but are not presented with the advertisements of the advertising campaign are called unexposed users. The method 400 begins at step 402. At step 402, the users of an advertising platform can be separated into one of exposed users and unexposed users. In one example, each user that has visited the advertising platform during the advertising campaign can be used. A unique identifier such as a user id or other identifier can be used to identify each user.

At step 404, exposure data can be obtained that characterizes a user's interaction with the advertising platform during the advertising campaign. The advertising campaign evaluation device 102 can, in one example, obtain the exposure data 320 from the database 108. In some examples, the exposure data 320 can be a count of the number of times that a user visits the advertising platform 114 during the advertising campaign. An advertising campaign can last for various periods of time. These certain periods of time can be divided into sub-periods. The exposure data can, for example, count the number of times that a user visits the advertising platform 114 during each sub-period of advertising campaign. For example, if an example advertising campaign lasts for four weeks, the exposure data can include the number of times in week 1 that the user visits the advertising platform, the number of times the user visits the advertising platform in week 2, the number of times the user visits the advertising platform in week 3 and the number of the times the user visits the advertising platform in week 4. In other examples, other types of exposure data 320 can be used.

After the advertising campaign evaluation device 102 obtains the exposure data 320, the exposure data can be structured for further processing. An example of the exposure data can be structured as shown below, where the each User ID is labeled with 1 if the user is an exposed user (i.e., was presented with the advertisement in the advertising campaign) and with a 0 if the user is an unexposed user (i.e., was not presented with the advertisement in the advertising campaign). As can be appreciated, the exposure data 320 as shown below can be obtained and structured for each user.

| User ID | Exposure_1 | Exposure_2 | Exposure_3 | Exposure_4 | Label |
|---|---|---|---|---|---|
| A | 30 | 5 | 15 | 12 | 1 |
| B | 12 | 7 | 6 | 4 | 0 |

The method 400 continues to step 406. At step 406, each user is categorized into one of a plurality of exposure bins based on the exposure data. In one example, the exposure model 302 of the advertising campaign evaluation device 102 can be built to determine a likelihood that a user will be exposed to the advertising campaign. A linear regression model, for example, can be built using the exposure data 320 as shown above. Any suitable linear regression model or open source tool known to one of ordinary skill in the art can be used to build the exposure model 302. The exposure model 302 can be built, for example, to determine an exposure score (e.g., a number between 0 and 1) that characterizes the likelihood that the user will be exposed to the advertising campaign.

Based on the exposure scores that are determined by the exposure model 302, two or more exposure bins can be determined. The exposure bins partition the users based on the likelihood that the user will be exposed to the advertising campaign as determined by the exposure model 302. For example, the exposure model 302 can partition the users into ten exposure bins based on the percentiles of the exposure score (e.g., bin 1=exposure score between 0 and 0.1, bin 2=exposure score between 0.11 and 0.2, bin 3=exposure score between 0.21 and 0.3, etc.). As a result, each user that visits the advertising platform during an advertising campaign can be categorized or assigned into an exposure bin using the exposure model 302. In other examples, other methodologies can be used to categorize and/or assign each user into one of the exposure bins.

At step 408, the sales feature data 330 can be obtained by the advertising campaign evaluation device 102. As previously discussed, the sales feature data 330 can characterize a user's purchase behavior on the advertising platform 114. In some examples, the sales feature data 330 can characterize a user's purchase behavior during time periods before the advertising campaign and during the advertising campaign. As will be explained, by using sales feature data 330 regarding a user's behavior both before and during the advertising campaign, the advertising campaign evaluation device 102 can identify a control group of unexposed user's that can better isolate and determine the effectiveness of the advertising campaign without the introduction of biasing or random factors that may influence a user's behavior in addition to or instead of the advertising campaign.

The sales feature data 330 can include, for example, the number the purchases that the user has made during the relevant time period as well as the volume or quantity of purchases made during the relevant time period. The sales feature data 330 can also include channel information. Channel information is information regarding the platform at which the user's purchase behavior was recorded. For example, the channel information can include information regarding whether the purchase by the user was made online, via a mobile application or other e-commerce platform. The channel information can also include whether the purchase by the user was made at a physical retail store. Further information regarding the physical retail store can include location, date, time, and method of payment. The sales feature data 330 can include the number of orders made during a time period and the size (in dollars, for example) of the order. The time periods can include, for example, the time period before the advertising campaign (i.e., pre-campaign) and the time period during the advertising campaign (i.e., in-campaign).

At step 408, the sales feature data 330 can be obtained for each user that has visited the advertising platform 114 during the advertising campaign. The sales feature data 330 can be obtained from the database 108, for example. In other examples, the sales feature data 330 can be obtained from other local, remote or other data sources or from third-party data sources. The sales feature data 330 can include various elements of data, sales_feature_1, sales_feature_2, . . . sales_feature_n. In one example, the sales feature data 330 can include pre-campaign online sales, in-campaign online sales, pre-campaign store sales, in-campaign store sales, and in-campaign store order count. An example of the sales feature data 330 organization is shown below.

| User ID | sales_feature_1 | sales_feature_2 | sales_feature_3 | sales_feature_4 | sales_feature_5 |
|---|---|---|---|---|---|
| A | 0 | 10.39 | 20.49 | 10.45 | 5 |
| B | 18.99 | 40.78 | 10.36 | 6.99 | 4 |

In other examples, the sales feature data 330 can include other data sets that may include pre-campaign online order count, pre-campaign store order count and in-campaign online order count. In still other examples, the sales feature data 330 can include other information that characterizes the user's purchase behavior on the advertising platform 114.

At step 410, the sales feature cluster engine 304 can categorize each user into one of a plurality of sales clusters based on the sales feature data 330. Any suitable methodology can be used to identify the plurality of sales clusters and then categorize each user into one of the sales clusters. In one example, the sales feature cluster engine 304 can apply K-means clustering to the sales feature data 330 previously described. In this example, the sales feature cluster engine 304 can partition the users into ten sales clusters. Each user can then be categorized or assigned into one of the ten clusters. The sales feature cluster engine 304 can create the sales clusters and assign the users into one of the sales clusters for each sales channel based on the channel information. Thus, each user can be categorized or assigned into a sales cluster based on store purchase behavior and for online purchase behavior. In instances in which there are multiple online platforms, the sales feature cluster engine can categorize each user into a sales cluster for each different online platform.

After the users have each been categorized into an exposure bin and into a sales cluster, the advertising campaign evaluation device 102 can organize the data into the data structure shown below.

| | | | online sales | store sales |
|---|---|---|---|---|
| User ID | label | exposure bin | cluster | cluster |
| A | 1 | 2 | 1 | 8 |
| B | 0 | 5 | 2 | 7 |

. . .

| | | | | |
|---|---|---|---|---|
| N | x | eb | osc | ssc |

A data set as shown in each row above can be determined for each user (A, B . . . N) that has visited the advertising platform 114 during the advertising campaign. The label for user ID is 1 for those users exposed to the advertising campaign and the label is 0 for those users that were not exposed to the advertising platform. Each user has been categorized or assigned into an exposure bin “eb” at step 406 and into, in one example, an online sales cluster “osb” and a store sales cluster “ssc.”

At step 412, the advertising campaign evaluation device 102 can define a control group that comprises unexposed users that are categorized into the same exposure bin and the same sales cluster as the exposed users. The control group can include unexposed users (i.e., with a label of 0) that are assigned into the same exposure bin, online sales cluster and store sales cluster as the exposed users (i.e., users with a label of 1). Thus, at step 412, the control group is defined that will be used to compare against a desired test group. For example, the group of exposed users (e.g., the test group) that has a label of 1 and are assigned into exposure bin 1, online sales cluster 1 and store sales cluster 1 will be compared against a control group of unexposed users that have a label of 0 and are assigned into exposure bin 1, online sales cluster 1 and store sales cluster 1. Similarly, exposed user that are assigned into exposure bin 2, online sales cluster 2 and store sales cluster 2 will be compared against a control group of unexposed users that are assigned into exposure bin 2, online sales cluster 2 and store sales cluster 2.

At step 414, the advertising campaign evaluation device 102 can compare the exposed users to the control group to determine an effect of the advertising campaign. Any suitable metric or quantitative measurable can be determined at step 414. Since the control group was defined as unexposed users that are assigned into the same exposure bins, online sales clusters and store sales clusters as the exposed users, biasing, randomness and other undesirable confounding effects can be minimized. Thus, a better determination of the performance and/or effectiveness of the advertising campaign can be determined.

As can be appreciated, it may be the case that there are not a sufficient amount of test group users and/or control group users in a certain subset of the users that are processed using the method 400 previously described. For example, when the number of users is small for a particular subset of users assigned to an exposure bin, online sales cluster and store sales cluster, the comparison between the test group and the control group can produce results that are not stable or reproducible.

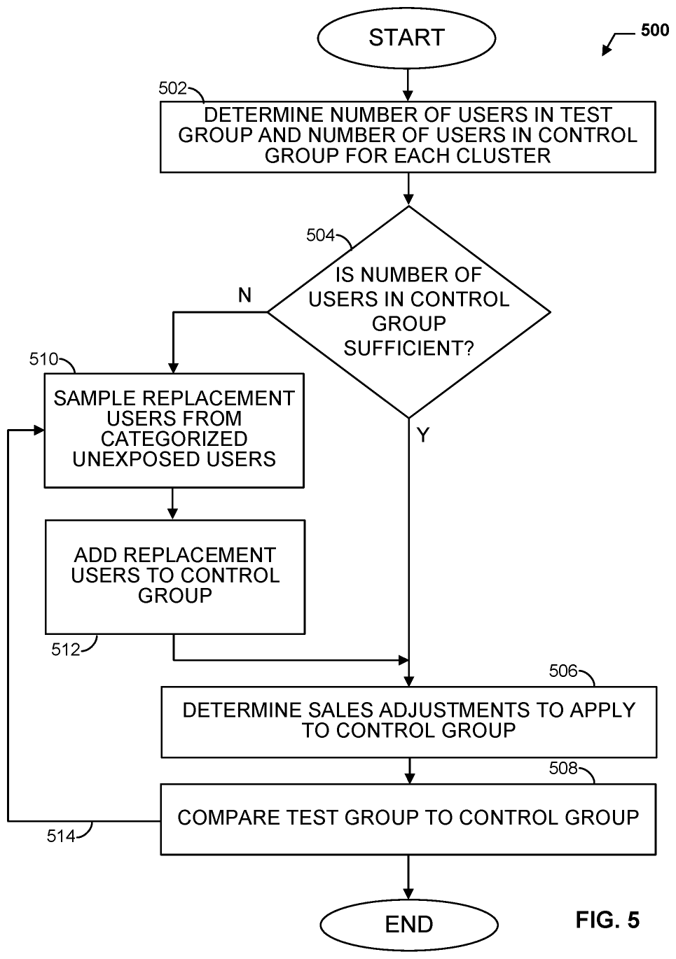

In such instance, the advertising campaign evaluation device 102 can perform the method 500 illustrated in FIG. 5. The method 500 can be performed in addition to the method 400 previously described. In one example, the method 500 can further describes step 412 of method 400 in which the control group is defined. Method 500 can define a control group for use by the advertising campaign evaluation device 102 to determine the performance or effectiveness of the advertising campaign. In other examples, the method 500 can be performed in connection with other methods of determining the performance or effectiveness of the advertising campaign.

As described below, the method 500 is described in the context of the method 400 previously described. At step 502, the advertising campaign evaluation device 102 can determine a number of users in the test group and a number of users in the control group. The advertising campaign evaluation device 102 can determine the number of users, for example, by counting the number of users that have been assigned to each unique set of exposure bins, online sales clusters and store sales clusters.

At step 504, the advertising campaign evaluation device 102 can determine if the number of users in the control group is sufficient. For example, the advertising campaign evaluation device 102 can determine if the number of users that are assigned into each exposure bin, online sales cluster and store sales cluster is greater than or equal to a predetermined user threshold. The predetermined user threshold can be any suitable number of users that can be used to reliably compare the test group to the control group. In one example, the predetermined threshold is ten users. Thus, the advertising evaluation campaign device 102 can count the number of users that are assigned to a particular exposure bin, online sales cluster and store sales cluster to determine if the number of users is greater than or equal to ten. If the number of users is greater than or equal to the predetermined user threshold, the number of users is sufficient and this group of users can be used for comparison purposes and the method proceed to step 506. If the number of users is less than the predetermined user threshold, the group will not be compared and used for comparison purposes.

The number of users in the control group can also be compared to the number of user in the test group at step 504. In order to be sufficient for comparison purposes the number of users in the control group should be the same as the number of users in the test group. In many instances the number of users in the control group can be less than the number of users in the test group. If the number of users in the control group is less than the number of users in the test group, the number of users in the control group is not sufficient and the method moves to step 510. If the number of users in the control group is equal to or greater than the number of users in the test group, then the number of users in the control group is sufficient and the method moves to step 506.

If the number of users in the control group is not sufficient, the advertising campaign evaluation device 102 can sample replacement users from categorized unexposed users at step 510. The sampling engine 306 may perform such a sampling action. The sampling engine 306 may perform bootstrapping. The sampling engine 306 may randomly select replacement users to be added into the control group data from the corpus of users that are assigned into the appropriate exposure bin, online sales cluster and store sales cluster. The sampling engine 306 may continue to sample replacement users into the control group until the number of users in the control group is equal to the number of users in the test group. The sampled replacement users can be added into the control group at step 512.

For example, the advertising campaign evaluation device 102 may count the number of test users and the number of control users that are assigned into exposure bin 1, online sales cluster 1 and store sales cluster 1. If the advertising campaign evaluation device 102 determines that the number of users in the test group (i.e., users that were exposed to the advertising campaign and are assigned into exposure bin 1, online sales cluster 1 and store sales cluster 1) is twelve and the number of users in the control group (i.e., users that were not exposed to the advertising campaign and are assigned into exposure bin 1, online sales cluster 1 and store sales cluster 1) is ten, the sampling engine 306 can sample replacement unexposed users into the control group. The sampling engine 306 can sample replacement users into the control group by randomly selecting one of the unexposed users that is already included in the control group and adding this sampled unexposed user (again) into the control group. In this example instance, the sampling engine 306 can sample two replacement users from the users in the control group. Thus, at the end of step 510, an unexposed user may can be sampled multiple times and be added to the control group at step 512.

Steps 504, 510 and 512 can also be performed for the test group (i.e., the number of exposed users). At step 504, the advertising campaign evaluation device 102 can determine whether the number of users in the test group is sufficient. The number of users in the test group can be compared against the predetermined user threshold, for example. The sampling engine 306 can sample replacement exposed users from the corpus of exposed users in the particular exposure bin, online sales cluster bin and store sales cluster bin when the number of users in the test group is not sufficient.

After performing steps 510 and 512, the advertising campaign evaluation device 102 has created a synthetic test group and a synthetic control group, if necessary, so that the number of users in each group is sufficient to stably and reliably compare the groups for determination of the effectiveness of the advertising campaign. As can be appreciated, if the number of users in either the test group of the control group is too small, the results of the comparison evaluations can be unreliable, unstable or misleading.

At step 506, the advertising campaign evaluation device 102 can determine sales adjustments to apply to the control group. Given that the test group and the control group are matched when they are assigned into sales clusters, there may be minor differences between the test group and the control group. During step 506, the pre-campaign sales behaviors can be compared. A sales adjustment parameter can be applied to the control group to equalize or normalize the pre-campaign sales behaviors between the test group and the control group. The sales adjustment parameter(s) can be stored, for example in database 108. The sales adjustment parameters can be retrieved and used during the comparison between the test group and the control group of the sales that occur for the control group during the advertising campaign period (i.e., in-campaign sales).

At step 508, the purchase data 340 of the test group can be compared to the purchase data 340 of the control group. This comparison can be performed by the advertising campaign comparator 308. The advertising campaign comparator 308 can determine any suitable metric or comparison, as previously described, to determine the performance or effectiveness of the advertising campaign.

As shown in FIG. 5, the process of sampling replacement users for either the test group or the control group, determining sales adjustments and comparing the test group to the control group can be repeated one or more times at loop 514. By repeating steps 510, 512, 506, and 508, the advertising campaign evaluation device 102 can determine a confidence interval, p-value or other statistical indicator associated with the results of the advertising campaign evaluation. The loop 514 can be repeated any suitable number of times. In one example, loop 514 is repeated at least 20 times. In other example, the loop 514 is repeated greater than 25 times. In other examples, the loop 514 is repeated other numbers of times.

The methods and apparatuses of the present disclosure can be used to quantify the effect of an advertising campaign on an advertising platform such as a website, mobile application or e-commerce platform. The apparatuses and methods are particularly suited to reduce and/or minimize bias that may be induced into quantitative measures of effectiveness of advertising campaigns when other methods are used.

Although the methods described above are with reference to the illustrated flowcharts, it will be appreciated that many other ways of performing the acts associated with the methods can be used. For example, the order of some operations may be changed, and some of the operations described may be optional.

In addition, the methods and systems described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
a computing device configured to:
obtain exposure data characterizing a user's interaction with an advertising platform during an advertising campaign;
categorize the user into one of a plurality of exposure bins based on the exposure data;
obtain sales feature data characterizing the user's purchase behavior on the advertising platform both before and during the advertising campaign;
categorize the user into one of a plurality of sales clusters based on the sales feature data;
define a control group comprising unexposed users categorized into the same exposure bins and sales clusters as exposed users; and
compare purchase data of the exposed users to the purchase data of the control group to determine an effect of the advertising campaign.

2. The system of claim 1, wherein the exposure data comprises data indicating the amount of visits to the advertising platform by the user.

3. The system of claim 1, wherein each exposure bin in the plurality of exposure bins identifies a likelihood that the user will be exposed to the advertising campaign.

4. The system of claim 1, wherein the sales feature data comprises a number of purchases made by the user on the advertising platform during the advertising campaign and a number of purchases made by the user in a period before the advertising campaign.

5. The system of claim 1, wherein each sales cluster of the plurality of sales clusters characterizes users having similar purchasing behaviors.

6. The system of claim 5, wherein the plurality of sales clusters is determined using k-means clustering.

7. The system of claim 1, wherein the computing device is further configured to determine if a number of users in the control group is greater than or equal to a predetermined user threshold and to add replacement users to the control group when the number of users in the control group is less than the predetermined user threshold.

8. A method comprising:
obtaining exposure data characterizing a user's interaction with an advertising platform during an advertising campaign;
categorizing the user into one of a plurality of exposure bins based on the exposure data;
obtaining sales feature data characterizing the user's purchase behavior on the advertising platform both before and during the advertising campaign;
categorizing the user into one of a plurality of sales clusters based on the sales feature data;
defining a control group comprising unexposed users categorized into the same exposure bins and sales clusters as exposed users; and
comparing purchase data of the exposed users to the purchase data of the control group to determine an effect of the advertising campaign.

9. The method of claim 8, wherein the exposure data comprises data indicating the amount of visits to the advertising platform by the user.

10. The method of claim 8, wherein each exposure bin in the plurality of exposure bins identifies a likelihood that the user will be exposed to the advertising campaign.

11. The method of claim 8, wherein the sales feature data comprises a number of purchases made by the user on the advertising platform during the advertising campaign and a number of purchases made by the user in a period before the advertising campaign.

12. The method of claim 8, wherein each sales cluster of the plurality of sales clusters characterizes users having similar purchasing behaviors.

13. The method of claim 12, wherein the plurality of sales clusters is determined using k-means clustering.

14. The method of claim 8, wherein the computing device is further configured to determine if a number of users in the control group is greater than or equal to a predetermined user threshold and to add replacement users to the control group when the number of users in the control group is less than the predetermined user threshold.

15. A non-transitory computer readable medium having instructions stored thereon, wherein the instructions, when executed by at least one processor, cause a device to perform operations comprising:
obtaining exposure data characterizing a user's interaction with an advertising platform during an advertising campaign;
categorizing the user into one of a plurality of exposure bins based on the exposure data;
obtaining sales feature data characterizing the user's purchase behavior on the advertising platform both before and during the advertising campaign;
categorizing the user into one of a plurality of sales clusters based on the sales feature data;
defining a control group comprising unexposed users categorized into the same exposure bins and sales clusters as exposed users; and
comparing purchase data of the exposed users to the purchase data of the control group to determine an effect of the advertising campaign.

16. The non-transitory computer readable medium of claim 15, wherein the exposure data comprises data indicating the amount of visits to the advertising platform by the user.

17. The non-transitory computer readable medium of claim 15, wherein each exposure bin in the plurality of exposure bins identifies a likelihood that the user will be exposed to the advertising campaign.

18. The non-transitory computer readable medium of claim 15, wherein the sales feature data comprises a number of purchases made by the user on the advertising platform during the advertising campaign and a number of purchases made by the user in a period before the advertising campaign.

19. The non-transitory computer readable medium of claim 15, wherein the plurality of sales clusters is determined using k-means clustering.

20. The non-transitory computer readable medium of claim 15, wherein the instructions, when executed by at least one processor, cause the device to perform operations comprising determining if a number of users in the control group is greater than or equal to a predetermined user threshold and adding replacement users to the control group when the number of users in the control group is less than the predetermined control group threshold.
